(19) United States
(12) Patent Application Publication
(10) Pub. No.: US 2016/0134709 A1
(43) Pub. Date: May 12, 2016

(54) METHOD, APPARATUS, AND COMPUTER PROGRAM PRODUCT FOR A NODE TO ADVERTISE ITS PRESENCE AND SERVICE PROFILES THEREOF IN A WIRELESS ENVIRONMENT

(71) Applicant: Nokia Corporation, Espoo (FI)

(72) Inventor: Teemu SAVOLAINEN, Nokia (FI)

(21) Appl. No.: 14/534,399

(22) Filed: Nov. 6, 2014

(51) Int. Cl. H04L 29/08; H04W 8/00; H04W 4/00

(52) U.S. Cl. CPC H04L 67/16; H04W 4/008; H04W 8/005

(57) ABSTRACT

In an example embodiment, a method to enhance wireless device advertising of service profiles includes maintaining, by an apparatus, a first service profile corresponding to a first wireless communication device address of the apparatus and a second service profile corresponding to a second wireless communication device address of the apparatus; determining, by the apparatus, a preference to communicate with wireless devices using the first service profile; transmitting, by the apparatus, wireless device discovery messages having the first wireless communication device address; and receiving, by the apparatus, a wireless response message from another wireless device, in response to the existence of the first device address in the transmitted device discovery messages, wherein the other device seeks the first service profile.

### FIELD

The technology field relates to wireless communication, and more particularly to wireless device advertising of service profiles.

### BACKGROUND

Modern society has adopted, and is becoming reliant upon, wireless communication devices for various purposes, such as, connecting users of the wireless communication devices with other users. Wireless communication devices can vary from battery powered handheld devices to stationary household and/or commercial devices utilizing electrical network as a power source. Due to rapid development of the wireless communication devices a number of areas capable of enabling entirely new types of communication applications have emerged.

One example of a wireless short-range communication technology is the Bluetooth™ Low Energy (LE). The Bluetooth™ Core Specification, Version 4.1, Bluetooth™ SIG, Dec. 3, 2013 (incorporated herein by reference), includes the Bluetooth LE protocol for products that require lower power consumption, lower complexity, and lower cost than would be possible using the Bluetooth basic rate/enhanced data rate (BR/EDR) protocol. Bluetooth LE is designed for applications not requiring high data rate, but a very-low power idle mode and a simple device discovery.

### SUMMARY

Method, apparatus, and computer program product example embodiments enhance wireless device advertising of service profiles.

An example embodiment of the invention includes a method comprising:

maintaining, by an apparatus, a first service profile corresponding to a first wireless communication device address of the apparatus and a second service profile corresponding to a second wireless communication device address of the apparatus;

determining, by the apparatus, a preference to communicate with wireless devices using the first service profile;

transmitting, by the apparatus, wireless device discovery messages having the first wireless communication device address; and

receiving, by the apparatus, a wireless response message from another wireless device, in response to the existence of the first device address in the transmitted device discovery messages, wherein the other device seeks the first service profile.

An example embodiment of the invention includes a method comprising:

wherein the other device seeks the first service profile, but does not seek the second service profile.

An example embodiment of the invention includes a method comprising:

wherein the other device and the apparatus have previously been connected so that the other device knows that by contacting the first wireless communication device address, the other device can reach the first service profile it seeks.

An example embodiment of the invention includes a method comprising:

transmitting, by the apparatus, wireless device discovery messages having the second wireless communication device address; and

receiving, by the apparatus, a wireless response message from another wireless device, in response to the existence of the second device address in the transmitted device discovery messages, wherein the other device seeks the second service profile.

An example embodiment of the invention includes a method comprising:

wherein the first wireless communication device address of the apparatus is one of a public device address of the apparatus or a random device address and the second wireless communication device address of the apparatus is one of a public device address of the apparatus or a random device address.

An example embodiment of the invention includes a method comprising:

receiving, by an apparatus, first wireless device discovery messages from an advertising device, having a first wireless communication device address corresponding to a first service profile of the advertising device;

determining, by the apparatus, that the first service profile corresponding to the first wireless communication device address, matches with the desired service profile; and

transmitting, by the apparatus, a response wireless message with a destination address of the first wireless communication device address.

An example embodiment of the invention includes a method comprising:

storing, by the apparatus, the first wireless communication device address in association with a representation of the first service profile.

An example embodiment of the invention includes a method comprising:

wherein the wireless discovery messages transmitted by the wireless communication device include a unique identifier representing the first service profile.

An example embodiment of the invention includes an apparatus comprising:

at least one processor;

at least one memory including computer program code;

the at least one memory and the computer program code configured to, with the at least one processor, cause the apparatus at least to:

maintain a first service profile corresponding to a first wireless communication device address of the apparatus and a second service profile corresponding to a second wireless communication device address of the apparatus;

determine a preference to communicate with wireless devices using the first service profile;

transmit wireless device discovery messages having the first wireless communication device address; and

receive a wireless response message from another wireless device, in response to the existence of the first device address in the transmitted device discovery messages, wherein the other device seeks the first service profile.

An example embodiment of the invention includes an apparatus comprising:

wherein the other device seeks the first service profile, but does not seek the second service profile.

An example embodiment of the invention includes an apparatus comprising:

wherein the other device and the apparatus have previously been connected so that the other device knows that by contacting the first wireless communication device address, the other device can reach the first service profile it seeks.

An example embodiment of the invention includes an apparatus comprising:

transmit wireless device discovery messages having the second wireless communication device address; and

receive a wireless response message from another wireless device, in response to the existence of the second device address in the transmitted device discovery messages, wherein the other device seeks the second service profile.

An example embodiment of the invention includes an apparatus comprising:

wherein the first wireless communication device address of the apparatus is one of a public device address of the apparatus or a random device address and the second wireless communication device address of the apparatus is one of a public device address of the apparatus or a random device address.

An example embodiment of the invention includes an apparatus comprising:

receive first wireless device discovery messages from an advertising device, having a first wireless communication device address corresponding to a first service profile of the advertising device;

determine that the first service profile corresponding to the first wireless communication device address, matches with the desired service profile; and

transmit a response wireless message with a destination address of the first wireless communication device address.

An example embodiment of the invention includes an apparatus comprising:

store the first wireless communication device address in association with a representation of the first service profile.

An example embodiment of the invention includes an apparatus comprising:

wherein the wireless discovery messages transmitted by the wireless communication device include a unique identifier representing the first service profile.

An example embodiment of the invention includes an apparatus comprising:

wherein the first service profile is Internet Protocol Support Profile (IPSP).

An example embodiment of the invention includes a computer program product comprising computer executable program code recorded on a computer readable, non-transitory storage medium, the computer executable program code comprising:

code for maintaining, by an apparatus, a first service profile corresponding to a first wireless communication device address of the apparatus and a second service profile corresponding to a second wireless communication device address of the apparatus;

code for determining, by the apparatus, a preference to communicate with wireless devices using the first service profile;

code for transmitting, by the apparatus, wireless device discovery messages having the first wireless communication device address; and

code for receiving, by the apparatus, a wireless response message from another wireless device, in response to the existence of the first device address in the transmitted device discovery messages, wherein the other device seeks the first service profile.

An example embodiment of the invention includes a computer program product comprising:

code for transmitting, by the apparatus, wireless device discovery messages having the second wireless communication device address; and

code for receiving, by the apparatus, a wireless response message from another wireless device, in response to the existence of the second device address in the transmitted device discovery messages, wherein the other device seeks the second service profile.

An example embodiment of the invention includes a computer program product comprising computer executable program code recorded on a computer readable, non-transitory storage medium, the computer executable program code comprising:

code for receiving, by the apparatus, first wireless device discovery messages from an advertising device, having a first wireless communication device address corresponding to a first service profile of the advertising device;

code for determining, by the apparatus, that the first service profile corresponding to the first wireless communication device address, matches with the desired service profile; and

code for transmitting, by the apparatus, a response wireless message with a destination address of the first wireless communication device address.

An example embodiment of the invention includes a computer program product comprising:

code for storing, by the apparatus, the first wireless communication device address in association with a representation of the first service profile.

### DESCRIPTION OF THE FIGURES

FIG. 1A is an illustration of an example embodiment of a network in a device discovery phase, wherein a mobile wireless device maintains a first service profile corresponding to a first wireless communication device address of the mobile wireless device and a second service profile corresponding to a second wireless communication device address of the mobile wireless device. The mobile wireless device is shown transmitting a wireless advertising message having the first wireless communication device address and a unique identifier representing the first service profile, in accordance with at least one embodiment of the present invention.

FIG. 1B is an illustration of an example embodiment of the network of FIG. 1A, wherein two wireless communication devices are scanning for advertising messages. A first scanning device is seeking a desired unique identifier representing the first service profile and a second scanning device is seeking a desired unique identifier representing the second service profile. The first scanning device is shown transmitting a response wireless message with a destination address of the first wireless communication device address, in response to having successfully compared the received first unique identifier representing the first service profile with the desired unique identifier representing its desired service profile, in accordance with at least one embodiment of the present invention.

FIG. 1C is an illustration of an example embodiment of the network of FIG. 1B, in a device discovery phase, wherein the mobile wireless device is shown transmitting a wireless advertising message having the second wireless communication device address and a second unique identifier representing the second service profile, in accordance with at least one embodiment of the present invention.

FIG. 1D is an illustration of an example embodiment of the network of FIG. 1C, wherein the second scanning device is shown transmitting a response wireless message with a destination address of the second wireless communication device address, in response to having successfully compared the received second unique identifier representing the second service profile with the desired unique identifier representing its desired service profile, in accordance with at least one embodiment of the present invention.

FIG. 2A is an illustration of an example flow diagram of an example process in the mobile wireless device, in accordance with at least one embodiment of the present invention.

FIG. 2B is an illustration of an example flow diagram of an example process in the scanning wireless device, in accordance with at least one embodiment of the present invention.

FIG. 3 illustrates an example embodiment of the invention, wherein examples of removable storage media are shown, based on magnetic, electronic and/or optical technologies, such as magnetic disks, optical disks, semiconductor memory circuit devices and micro-SD memory cards (SD refers to the Secure Digital standard) for storing data and/or computer program code as an example computer program product, in accordance with at least one embodiment of the present invention.

### DISCUSSION OF EXAMPLE EMBODIMENTS OF THE INVENTION

This section is organized into the following topics:
A. Wireless Short-Range Communication Networks
B. Bluetooth™ Low Energy (LE) Technology
C. Using Dedicated Bluetooth™ Low Energy Device Addresses For Each Service In Multi-Profile Enabled Bluetooth™ Low Energy Nodes

A. Wireless Short-Range Communication Networks

Short-range communication technologies provide communication solutions appropriate for many data applications, without the cost, traffic and legislative concerns of longer-range communication technologies. Popular short-range communication technologies include Bluetooth basic rate/enhanced data rate (BR/EDR), Bluetooth Low Energy (LE), IEEE 802.11 wireless local area network (WLAN), Wireless Universal Serial Bus (WUSB), ZigBee (IEEE 802.15.4, IEEE 802.15.4a), and near field communication technologies, such as radio frequency identification (RFID) and near field communication (NFC) technology that enable contactless identification and interconnection of wireless devices. Bluetooth LE technology provides an example of wireless short-range communication establishment.

B. Bluetooth™ Low Energy (LE) Technology

The Bluetooth LE protocol allows a star network topology in connections, where one device serves as a master for a plurality of slave devices. The master device dictates the connection timing and communication operations of the one or more slave devices. Bluetooth LE communicates over a total of 40 RF channels, each separated by 2 MHz. Data communication between Bluetooth LE devices occurs in 37 pre-specified data channels, of the 40 RF channels. All data connection transmissions occur in connection events wherein a point-to-point connection is established between the master device and a slave device. In the Bluetooth LE protocol, a slave device provides data through Bluetooth LE communication to the master device to which it is connected. The remaining 3 channels, of the 40 RF channels, are advertising channels used by devices to advertise their existence and capabilities. The Bluetooth LE protocol defines a unidirectional connectionless broadcast mode on the advertising channels.

Devices that transmit advertising packets on the advertising PHY channels are referred to as advertisers. Devices that receive advertising on the advertising channels without the intention to connect to the advertising device are referred to as scanners. Transmissions on the advertising PHY channels occur in advertising events. At the start of each advertising event, the advertiser sends an advertising packet corresponding to the advertising event type. Depending on the type of advertising packet, the scanner may make a request to the advertiser on the same advertising PHY channel which may be followed by a response from the advertiser on the same advertising PHY channel. The advertising PHY channel changes on the next advertising packet sent by the advertiser in the same advertising event. The advertiser may end the advertising event at any time during the event. The first advertising PHY channel is used at the start of the next advertising event.

For all undirected advertising events, the time between the start of two consecutive advertising events (T_advEvent) is computed for each advertising event as follows:

T_advEvent=advInterval+advDelay.

The advInterval is an integral multiple of 0.625 ms in the range of 20 ms to 10.24 s. If the advertising event type is either a scannable undirected event type or a non-connectable undirected event type, the advInterval is not less than 100 ms. If the advertising event type is a connectable undirected event type, the advInterval may be 20 ms or greater.

The advDelay is a pseudo-random value with a range of 0 ms to 10 ms generated by the Link Layer for each advertising event. Devices that are trying to form a connection to another device listen for connectable advertising packets. Such devices are referred to as initiators. If the advertiser is using a connectable advertising event, an initiator may transmit a connection request using the same advertising PHY channel on which it received the connectable advertising packet. The advertising event is ended and connection events begin if the advertiser receives and accepts the request for a connection be initiated. Once a connection is established, the initiator becomes the master device in what is referred to as a piconet and the advertising device becomes the slave device. Connection events are used to send data packets between the master and slave devices.

The format of Advertising data and Scan Response data consists of a significant part and a non-significant part. The significant part contains a sequence of AD structures. Each AD structure may have a Length field of one octet, which contains the Length value, and a Data field of Length octets. The first octet of the Data field contains the AD type field. The content of the remaining Length-1 octet in the Data field depends on the value of the AD type field and is called the AD data. The non-significant part extends the Advertising and Scan Response data to 31 octets and may contain all-zero octets.

Devices are identified using a device address. Device addresses may be either a public device address or a random device address. A public device address and a random device address are both 48 bits in length. A device may contain at least one type of device address and may contain both.

The public device address may be created in accordance with section 9.2 (“48-bit universal LAN MAC addresses”) of the IEEE 802-2001 standard (http://standards.ieee.org/getieee802/download/802-2001.pdf) and using a valid Organizationally Unique Identifier (OUI) obtained from the IEEE Registration Authority (http://standardsleee.org/regauth/oui/forms/ and sections 9 and 9.1 of the IEEE 802-2001 specification).

The public device address is divided into the following two fields:
company_assigned field is contained in the 24 least significant bits
company_id field is contained in the 24 most significant bits

The random device address may be of either of the following two sub-types:
Static address
Private address

The private address may be of either of the following two sub-types:
Non-resolvable private address
Resolvable private address

Static and non-resolvable private address both contains address that is random. The main difference is that the device may not change its static address value once initialized until the device is power cycled.

The random resolvable private device address is divided into the following two fields which can be used to identify the device:
hash field is contained in the 24 least significant bits, as defined in [Vol. 3] Part C, Section 10.8.2.3 of the Bluetooth™ Core Specification, Version 4.1.
random field is contained in the 24 most significant bits, as defined in [Vol. 3] Part C, Section 10.8.2.2 of the Bluetooth™ Core Specification, Version 4.1.

The Bluetooth LE Link Layer provides a state machine with the following five states: Standby State, Advertising State, Scanning State, Initiating State, and Connection State. The Link Layer state machine allows only one state to be active at a time. The Link Layer in the Standby State does not transmit or receive any packets and can be entered from any other state. The Link Layer in the Advertising State will be transmitting advertising channel packets and possibly listening to and responding to responses triggered by these advertising channel packets. A device in the Advertising State is known as an advertiser. The Advertising State can be entered from the Standby State. The Link Layer in the Scanning State will be listening for advertising channel packets from devices that are advertising. A device in the Scanning State is known as a scanner. The Scanning State can be entered from the Standby State. The Link Layer in the Initiating State will be listening for advertising channel packets from a specific device and responding to these packets to initiate a connection with that specific device. A device in the Initiating State is known as an initiator. The Initiating State can be entered from the Standby State. The Connection State of the Link Layer may be entered either from the Initiating State or the Advertising State. A device in the Connection State is known as being in a connection over a data channel. Within the Connection State, two roles are defined: the Master Role and the Slave Role. When a device in the Initiating State, enters the Connection State, it is in the Master Role, it exchanges data packets with a slave device in a data channel, and it defines the timings of transmissions. When a device in the Advertising State, enters the Connection State, it is in the Slave Role and exchanges data packets with a master device in a data channel, wherein the master device defines the timings of transmissions.

The Bluetooth LE radio operates in the unlicensed 2.4 GHz ISM band, in the same manner as does the Basic Rate/Enhanced Data Rate (BR/EDR) radio. Bluetooth LE supports very short data packets, from 10 octets to a maximum of 47 octets, giving it a low duty cycle. Bluetooth LE employs a frequency hopping transceiver with many frequency hopping spread spectrum (FHSS) carriers, with a bit rate of 1 Megabit per second (Mb/s).

Bluetooth LE employs two multiple access schemes: Frequency division multiple access (FDMA) and time division multiple access (TDMA). Forty (40) physical channels, separated by 2 MHz, are used in the FDMA scheme. Three (3) are used as advertising channels and 37 are used as data channels. A TDMA based polling scheme is used in which one device transmits a packet at a predetermined time and a corresponding device responds with a packet after a predetermined interval.

The physical channel is sub-divided into time units known as events. Data is transmitted between Bluetooth LE devices in packets that are positioned in these events. There are two types of events: Advertising and Connection events.

Devices that transmit advertising packets on the advertising Physical Layer (PHY) channels are referred to as advertisers. Devices that receive advertising on the advertising channels without the intention to connect to the advertising device are referred to as scanners. Devices that form a connection to another device by listening for connectable advertising packets, are referred to as initiators. Transmissions on the advertising PHY channels occur in advertising events.

In the Bluetooth™ Core Specification, Version 4.1, there are four advertising event types: connectable undirected advertising (ADV_IND), connectable directed advertising (ADV_DIRECT_IND), scannable undirected advertising (ADV_SCAN_IND), and non-connectable undirected advertising (ADV_NONCONN_IND). At the start of each advertising event, the advertiser sends an advertising packet corresponding to the advertising event type. The header of the advertising channel packet identifies the packet type in a four-bit PDU Type field encoding. There are seven values currently assigned to the four-bit PDU Type field, ranging from 0000 to 0110, with the values 0111 to 1111 being reserved for future use.

The initiator device that receives the advertising packet, may make a connect request (CONNECT_REQ) to the advertiser device on the same advertising PHY channel. The CONNECT_REQ request includes fields for access address AA, CRC, WinSize, WinOffset, Interval, Latency, Timeout, ChannelMap, Hop count, and sleep clock accuracy SCA. The four-bit PDU Type field in the header of the CONNECT_REQ advertising channel packet, is 0101. When the advertiser device accepts the CONNECT_REQ request, a point-to-point connection results between the initiator device that becomes the master device, and the advertiser device that becomes the slave device in a piconet. The master and the slave devices know at what time and in which frequency the connection is in operation. The data channel changes between every connection event and the start of connection events are spaced regularly with the connection interval that is provided in the CONNECT_REQ packet.

In the connectable undirected advertising (ADV_IND) channel packet, the ADV_IND PDU has a payload field containing AdvA and AdvData fields. The AdvA field contains the advertiser's public or random device address and the AdvData field may contain Advertising data from the advertiser's host. The PDU may be used in connectable undirected advertising events. The four-bit PDU Type field in the header of the ADV_IND advertising channel packet, is 0000.

In the connectable directed advertising (ADV_DIRECT_IND) channel packet, the ADV_DIRECT_IND PDU has the payload field containing AdvA and InitA fields. The AdvA field contains the advertiser's public or random device address. The InitA field is the address of the device to which this PDU is addressed. The InitA field may contain the initiator's public or random device address. The PDU may be used in connectable directed advertising events. This packet may not contain any host data. The four-bit PDU Type field in the header of the ADV_DIRECT_IND advertising channel packet, is 0001.

In a non-connectable undirected event type advertising channel packet, ADV_NONCONN_IND, a scanner device is allowed to receive information in the advertising channel packet, but scanner/initiator devices are not allowed to transmit anything in the advertising channels upon receiving the ADV_NONCONN_IND advertising channel packets. When the non-connectable undirected event type is used, non-connectable advertising indications ADV_NONCONN_IND packets are sent by the Link Layer. The non-connectable undirected event type allows a scanner to receive information contained in the ADV_NONCONN_IND from the advertiser. The advertiser may either move to the next used advertising channel index or close the advertising event after each ADV_NONCONN_IND that is sent. The four-bit PDU Type field in the header of the ADV_NONCONN_IND advertising channel packet, is 0010.

In the scannable undirected advertising (ADV_SCAN_IND) channel packet, the ADV_SCAN_IND PDU has the payload field containing AdvA and AdvData fields. The AdvA field contains the advertiser's public or random device address. The PDU may be used in scannable undirected advertising events. The AdvData field may contain Advertising Data from the advertiser's host. The four-bit PDU Type field in the header of the ADV_SCAN_IND advertising channel packet, is 0110.

In the Bluetooth™ Core Specification, Version 4.1, if the advertiser is using a connectable advertising event, an initiator may make a connection request using the same advertising PHY channel on which it received the connectable advertising packet. The advertising event is ended and connection events begin if the advertiser receives and accepts the request for a connection to be initiated. Once a connection is established, the initiator becomes the master device in a piconet and the advertising device becomes the slave device. Within a connection event, the master and slave alternate sending data packets using the same data PHY channel.

According to the Bluetooth Specification V4.1, Bluetooth LE device discovery involves different operational processes for devices with different roles. In particular:
Slave Device, being an advertiser, performs an advertising process during which the device repeatedly enters Advertising Events. The interval of each start of Advertising Event, Ta, composes of a fixed-length “advInterval” and a random-length “advDelay”. In Advertising Event, the device sends advertising Packet Data Units (PDUs) in broadcasting channel 37, 38 and 39, respectively.
Master Device, being an initiator/scanner, performs the initiating/scanning process. An initiating/scanning process consists of repeated “scanInterval”, each of which contains a “scanWindow”. In a different “scanWindow”, the device changes the RF module to receive the state and listens to advertising PDUs on different broadcasting channels; while out of the “scanWindow”, it does routine scheduling, or turns off the RF module.

If any advertising PDU is received by an initiator/scanner, it means the initiator/scanner successfully discovers the advertising device. For the initiator, it can directly send back a “CONN_REQ” to establish a connection with that advertiser. For a scanner, it can send out a “SCAN_REQ” to ask for more information from that advertiser.

Example non-limited use cases for Bluetooth LE technology include sports and fitness, security and proximity, smart energy, and IPv6 over Bluetooth LE communications technology (https://tools.ietf.org/html/draft-ietf-6lo-btle-03). Bluetooth LE technology is designed for devices to have a battery life of up to one year such as those powered by coin-cell batteries. These types of devices include watches that will utilize Bluetooth LE technology to display Caller ID information and sports sensors that will be utilized to monitor the wearer's heart rate during exercise. The Medical Devices Working Group of the Bluetooth SIG is also creating a medical devices profile and associated protocols to enable Bluetooth applications for Bluetooth LE devices. The Internet Working Group of the Bluetooth SIG is developing an “Internet Protocol Support Profile (IPSP)” that enables transmission of IPv6 packets over Bluetooth LE. IPSP is a particularly likely profile to be enabled on a Bluetooth LE device, alongside other profiles.

A Bluetooth LE advertising channel may be shared by any number of Bluetooth LE devices. Any number of Bluetooth LE devices may transmit advertising packets while sharing the same three advertising PHY channels. In high-density environments, however, since there are a large number of nodes to be discovered, the probability of broadcasting conflict will inevitably increase, causing network access time to increase, and also lowering the energy efficiency of the whole network.

The Bluetooth Low Energy (LE) specification provides means for link layer level device filtering. The link layer (LL) may perform device filtering based on device address of the peer device. LL device filtering is used by the LL to minimize the number of devices to which it responds. Device filtering builds upon concept of white list. A white list contains a set of white list records which each contains both the device address and the device address type (public or random). On reset, the white list is empty. The white list is configured by the host and is used by the LL to filter advertisers, scanners or initiators. One may deploy filter policies for advertising, scanning and initiating.

The advertising filter policy determines how the advertiser's LL processes scan and/or connection requests. The LL may be configured by the host to one of the following modes:
To process scan and connection requests only from devices in the white list
To process scan and connection requests from all devices (i.e. the white list is not in use). This is the default mode on reset.
To process scan requests from all devices and connection requests only from devices in the white list
To process connection requests from all devices and scan requests only from devices in the white list

The scanner filter policy determines how the scanner's LL processes advertising packets. The LL may be configured by the host to one of the following modes:
To process advertising packets only from devices in the white list
To process advertising packets from all devices (i.e. the white list is not in use). This is the default mode on reset.

Bluetooth™ Host Controller Interface

The Bluetooth™ radio in a device may include the host controller interface that provides a command interface between the host application in the device and the link layer of the Bluetooth™ radio, also referred to as the controller, to enable access to hardware status and control registers of the Bluetooth™ radio.

The host controller interface (HCI) is described in the Bluetooth™ Core 4.1 Specification. The Host will receive asynchronous notifications of HCI events from Host Controller Transport Layer. HCI events are used for notifying the Host when something occurs. When the Host discovers that an event has occurred, it will then parse the received event packet to determine which event occurred. The commands and events are sent between the Host and the Controller. These are grouped into logical groups by function.

The HCI provides a command interface between the host application in a device and the Bluetooth™ link layer, provides access to hardware status and control registers of the Bluetooth™ radio, and provides a uniform method of accessing the Bluetooth™ baseband capabilities. In example embodiments, the HCI may provide a means for the host application to define different device addresses to be associated with some profiles and/or to query the device controller as to whether it supports example features of the invention.

Discovery Phase HCI Commands and Events

HCI LE Advertising Report Event

The Bluetooth LE device discovery group of commands and events allow a device to discover other devices in the surrounding area. The Bluetooth LE host controller interface includes the HCI LE Advertising Report event that indicates that a Bluetooth device or multiple Bluetooth devices have been detected during an active scan or during a passive scan.

C. Using Dedicated Bluetooth™ Low Energy Device Addresses for Each Service in Multi-Profile Enabled Bluetooth™ Low Energy Nodes

It would be desirable to support scenarios in Bluetooth™ Low Energy networks, where a device that supports multiple service profiles, wishes to connect only with one of the service profiles at any one time. However, Bluetooth™ Low Energy devices establish connections solely based on device addresses. A scanning device will only look at the device address of the advertiser when making a decision whether to connect to the advertiser. What is needed is a way for a Bluetooth™ Low Energy advertising device that supports multiple service profiles, to enable scanning devices receiving its advertising packets, to determine whether the advertiser offers a desired service profile.

In accordance with an example embodiment of the invention, an advertising Bluetooth™ Low Energy device maintains a first service profile corresponding to a first wireless communication device address of the advertiser and a second service profile corresponding to a second wireless communication device address of the advertiser. For example, the first wireless communication device address of the advertiser may be a public device address of the advertiser and the second wireless communication device address of the advertiser may be a random device address. For example, the advertiser may support the Internet Protocol Support Profile (IPSP) and the Weight-Scale profile. The advertiser may choose to use its public address to correspond to the Weight-Scale profile and a random device address for the IPSP profile. In this manner, the advertiser may allocate Bluetooth™ Low Energy device addresses separately for each profile that it maintains, so that it may select a preferred profile and corresponding device address to advertise its presence to specific devices.

For example, The Bluetooth™ Low Energy device A may send advertising packets for service profile(1) using Bluetooth™ Low Energy device address ADDR1 and may send other advertising packets for service profile(2) using Bluetooth™ Low Energy device address ADDR2. The a scanning Bluetooth™ Low Energy device B may discover the advertising device A through A's address ADDR1. A scanning Bluetooth™ Low energy device C may discover the advertising device A through A's address ADDR2. When advertising device A wishes to have a connection to its service profile(1), the advertising device A sends advertising packets using ADDR1. This avoids the problem of scanning device C's unwanted connection, as scanning device C would need to recognize the device address ADDR2 before connecting.

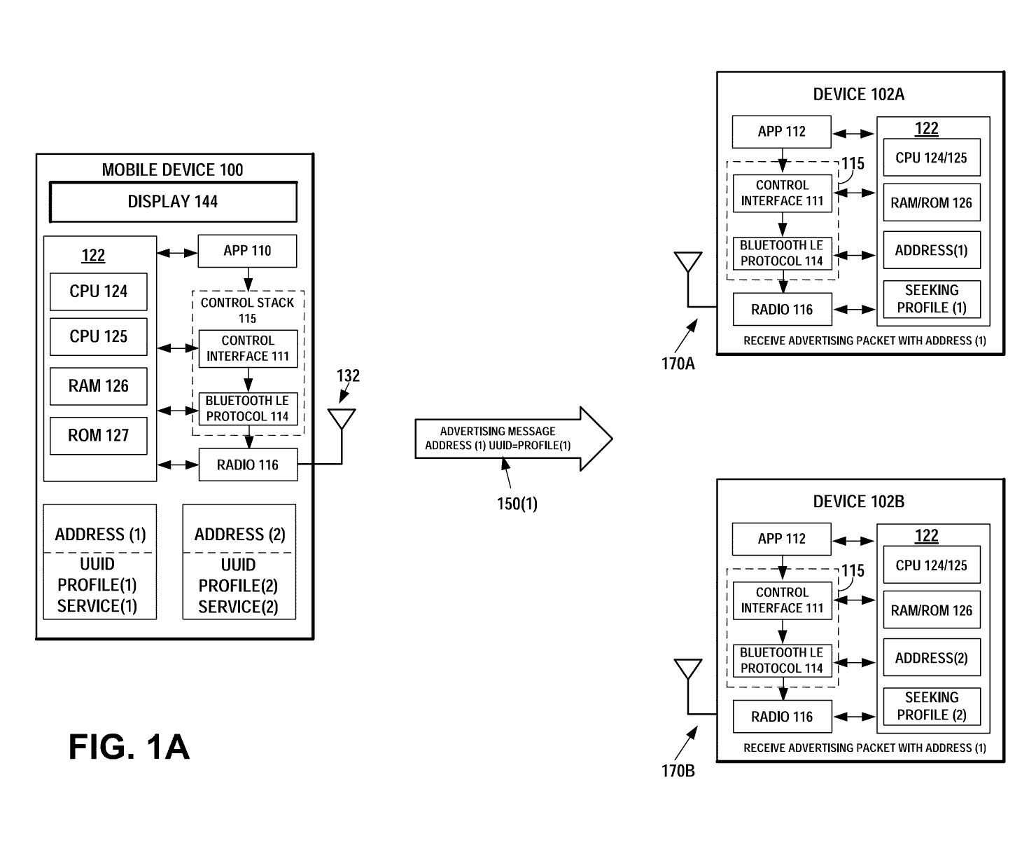

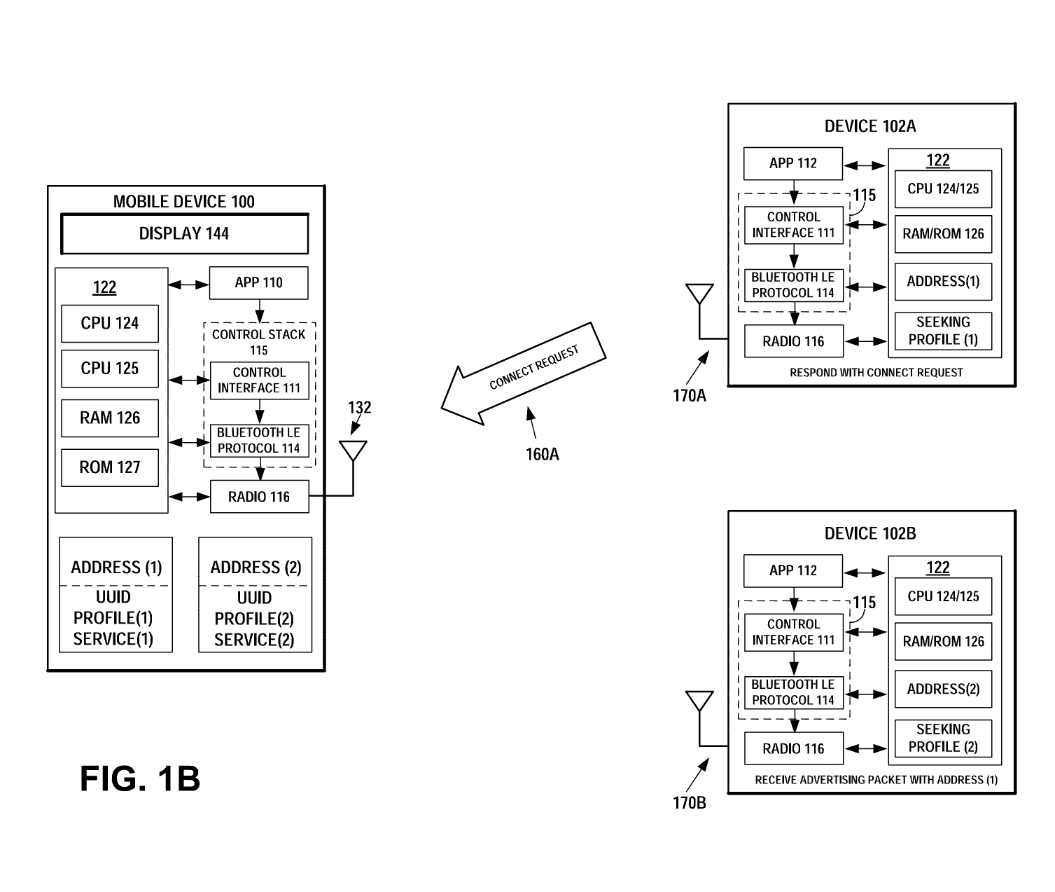

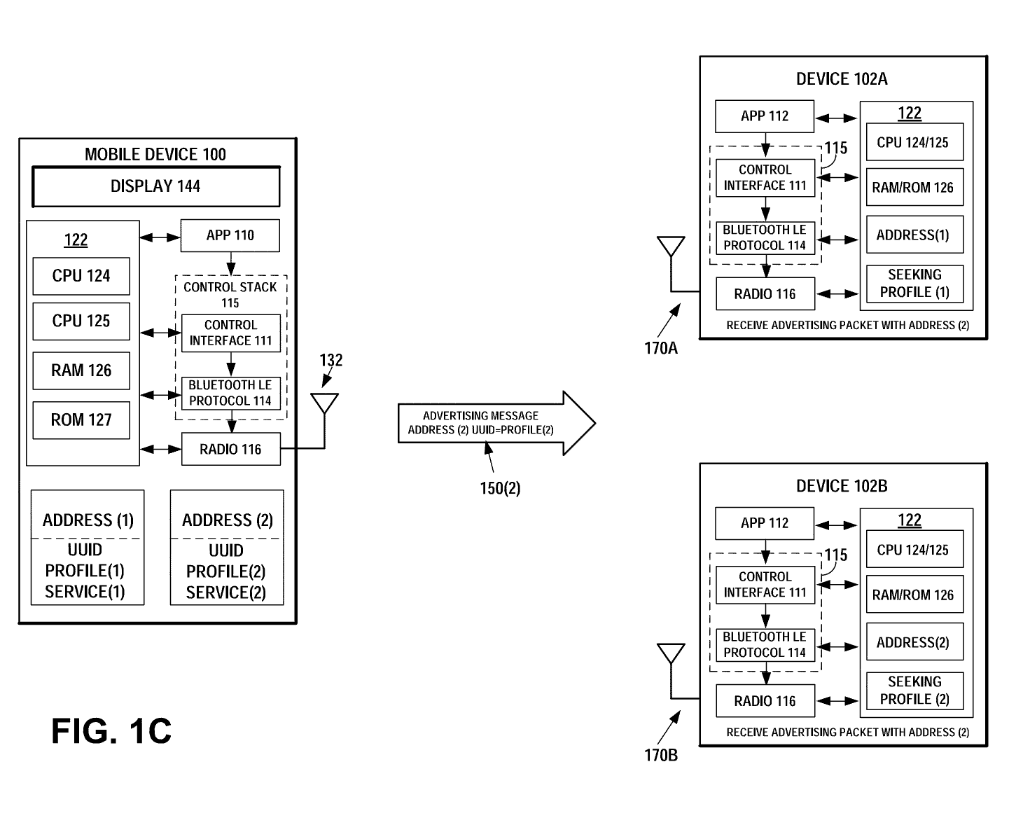

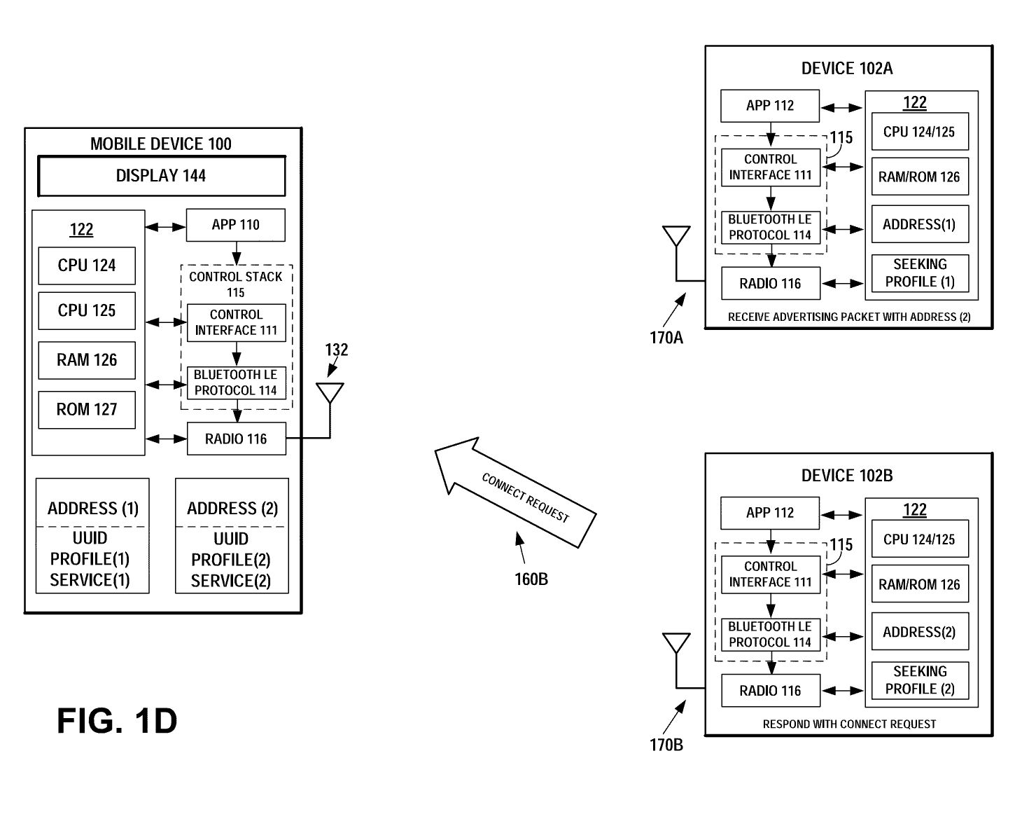

FIG. 1A is an illustration of an example embodiment of a network in a device discovery phase, wherein a mobile wireless device 100 maintains a first service profile, Profile(1), for a service, Service(1), corresponding to a first wireless communication device address, Address(1), of the mobile wireless device 100. The mobile wireless device 100 maintains a second service profile, Profile(2), for a service, Service(2), corresponding to a second wireless communication device address, Address(2), of the mobile wireless device 100. For example, the first wireless communication device address, Address(1), of the advertiser 100 may be a public device address of the advertiser 100 and the second wireless communication device address, Address(2), of the advertiser 100 may be a random device address.

The mobile wireless device 100 is shown transmitting a wireless advertising message 150(1) having the first wireless communication device address, Address(1), and a unique identifier representing the first service profile, Profile(1).

The mobile wireless device 100, such as a smart phone, transmits wireless device discovery messages 150(1), such as Bluetooth™ Low Energy advertising packets. Two wireless communication devices 102A and 102B are scanning for Bluetooth™ Low Energy advertising packets. The first scanning device 102A is seeking a desired unique identifier representing the first service profile, Profile(1), and the second scanning device 102B is seeking a desired unique identifier representing the second service profile, Profile(2).

Initially the mobile wireless device 100 and the two wireless communication devices 102A and 102B do not know each other. The wireless communication device 102A, for example, may be interested in discovering the first service profile, Profile(1), on any wireless device and is scanning for devices. The mobile wireless device 100 may determine a preference to communicate with wireless devices using the first service profile, Profile(1). The mobile wireless device 100 transmits advertising packets that include the universally unique identifier (QUID) of the first service profile, Profile(1) and have the device address, Address(1). The wireless communication device 102A, sees this advertisement for the first time, and thus learns that the device address, Address(1) that mobile wireless device 100 used for sending advertising packet, may be mapped to the first service profile, Profile(1). The wireless communication device 102A may then, at this point, create a connection to the mobile wireless device 100. The wireless communication device 102A also stores in its memory, an association of the device address, Address(1), with the UUID of the first service profile, Profile(1). Later on, if the wireless communication device 102A is again scanning for devices having the first service profile, Profile(1), when the wireless communication device 102A receives an advertising packet with the device address, Address(1), this triggers connection establishment procedures for connecting the wireless communication device 102A to the advertiser, the mobile wireless device 100. The wireless communication device 102A knows that by contacting the first wireless communication device address, Address(1), it can reach the first service profile, Profile(1), that it seeks. A similar operation would take place in wireless communication device 102B.

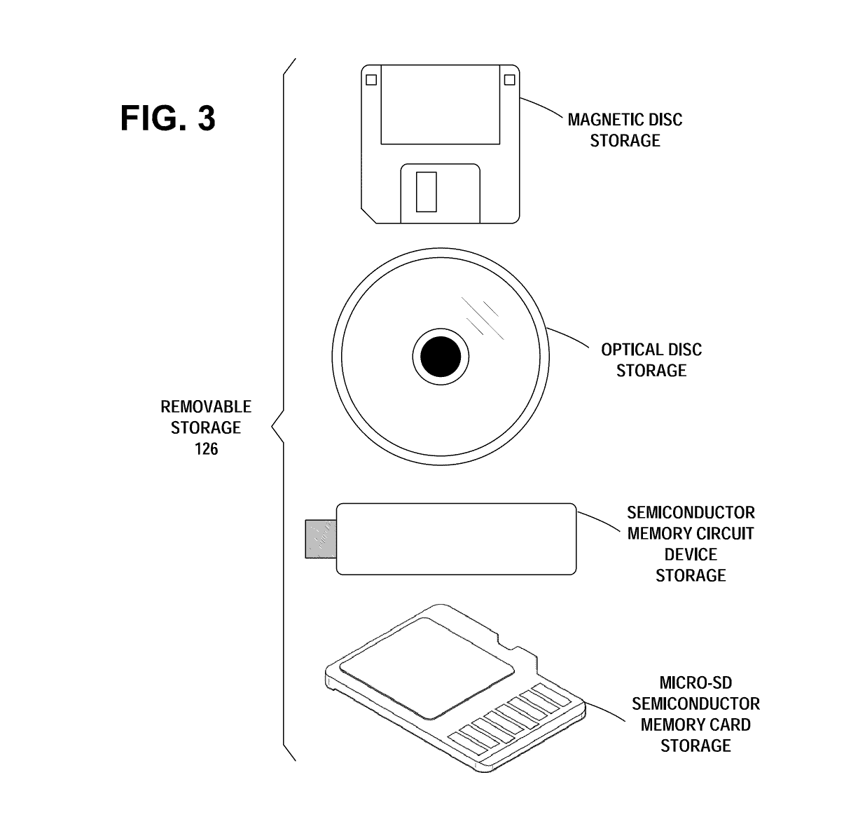

In example embodiments of the invention, the wireless mobile device 100 and the two wireless communication devices 102A and 102B may include a processor 122 that includes from one to many central processing units (CPUs) 124 and/or 125, a random access memory (RAM) 126, a read only memory (ROM) 127, and interface circuits to interface with one or more radio transceivers 116, antenna 132, 170A, 170B, and battery or house power sources or energy harvesting technologies. A smart phone may include a keypad, display 144, etc. The RAM and ROM can be removable memory devices such as smart cards, SIMs, WIMs, semiconductor memories such as RAM, ROM, PROMS, flash memory devices, etc., as shown in FIG. 3.

In an example embodiment of the invention, the Bluetooth mobile wireless device 100 and the two wireless communication devices 102A and 102B may include control stack 115 that includes a host controller interface (HCI) 111 that provides a command interface between the host respective application 110, 112 in the device and the Bluetooth™ Low Energy MAC 114. The control stack 115, also referred to as the controller, to enables access to hardware status and control registers of the Bluetooth radio 116. The host controller interface (HCI) is described in the Bluetooth™ Core Specification. The Host application 110, 112, will receive asynchronous notifications of HCI events from HCI 111. HCI events are used for notifying the Host application 110, 112, when something occurs. When the Host application discovers that an event has occurred, it will then parse the received event packet to determine which event occurred. The commands and events are sent between the Host application 110, 112, and the radio 116. The HCI 111 provides a command interface between the host application 110, 112, in a device and the Bluetooth™ Low Energy MAC 114, provides access to hardware status and control registers of the radio 116, and provides a uniform method of accessing the Bluetooth baseband capabilities.

In an example embodiment of the invention, the MAC 114 may be the Bluetooth Low Energy (LE) protocol.

In an example embodiment of the invention, the mobile wireless device 100 outputs Bluetooth LE advertising packets on the advertising PHY channels in advertising events. During Bluetooth LE transmission, the RF signal is transmitted by the antenna 132.

In an example embodiment of the invention, the mobile wireless device 100 may be, for example, a miniature device such as a key fob, smart card, jewelry, or the like. With Internet Protocol Support Profile (IPSP), advertisements may be sent by Internet of Things nodes, such as sensors, actuators, and the like. The wireless device 100 may be an Internet of Things node or smart object. In an example embodiment of the invention, the mobile wireless device 100 may be, for example, a relatively larger cell phone, smart phone, flip-phone, PDA, graphic pad. The mobile wireless device 100 may also be in an automobile or other vehicle. The wireless device 102A and 102B may be, for example, audio speakers, video displays, or other types of wireless communications equipment that are either in a fixed position or mobile. In embodiments, the relative sizes of devices 100, 102A, 102B may be arbitrary.

FIG. 1B is an illustration of an example embodiment of the network of FIG. 1A, wherein two wireless communication devices 102A and 102B are scanning for advertising messages. A first scanning device 102A is seeking a desired unique identifier representing the first service profile, Profile(1), and a second scanning device is seeking a desired unique identifier representing the second service profile, Profile(2).

The first scanning device 102A has received the advertising packet 150(1) and is shown transmitting a response wireless message 160A with a destination address of the first wireless communication device address, Address(1), in response to having successfully compared the received first unique identifier representing the first service profile, Profile(1), with the desired unique identifier representing its desired service profile, in accordance with at least one embodiment of the present invention. When the advertising packets 150 are received by device 102A, the UUID in the advertising packet 150(1) is stored and associated with the device address in the packet. The second scanning device 102B does not respond to the advertising packet 150(1) because it does not recognize the first wireless communication device address, Address(1).

FIG. 1C is an illustration of an example embodiment of the network of FIG. 1B, in a device discovery phase, wherein the mobile wireless device 100 is shown transmitting a wireless advertising message 150(2) having the second wireless communication device address, Address(2) and a second unique identifier representing the second service profile, Profile(2).

FIG. 1D is an illustration of an example embodiment of the network of FIG. 1C, wherein the second scanning device 102B is shown transmitting a response wireless message 160B with a destination address of the second wireless communication device address Address(2), in response to having received the advertising packet 150(2) and successfully compared the received second unique identifier representing the second service profile, Profile(2), with the desired unique identifier representing its desired service profile, in accordance with at least one embodiment of the present invention. When the advertising packets 150(2) are received by device 102B, the UUID in the advertising packet 150(2) is stored and associated with the device address, Address(2), in the packet. The first scanning device 102A does not respond to the advertising packet 150(2) because it does not recognize the second wireless communication device address, Address(2).

In example embodiments of the invention, the scanning wireless device 102A may be multi-profile enabled and be seeking both the first service profile, Profile(1), and the second service profile, Profile(2). However, if the mobile wireless device 100 (which is also multi-profile enabled) wants to only use one profile for communications and thus only transmits advertisement packets with the second device address, Address(2), for example, the scanning device 102A only responds regarding the second profile, Profile(2).

In example embodiments of the invention, the advertising device 100 may have two public device addresses (one for each profile). Alternately, the advertising device 100 may use random device addresses for each profile. In example embodiments of the invention, the advertising device 100 may have more than two profiles in use, each of which corresponds to a different public or random address. Any combination of unique public addresses and random addresses with any number of profiles is possible.

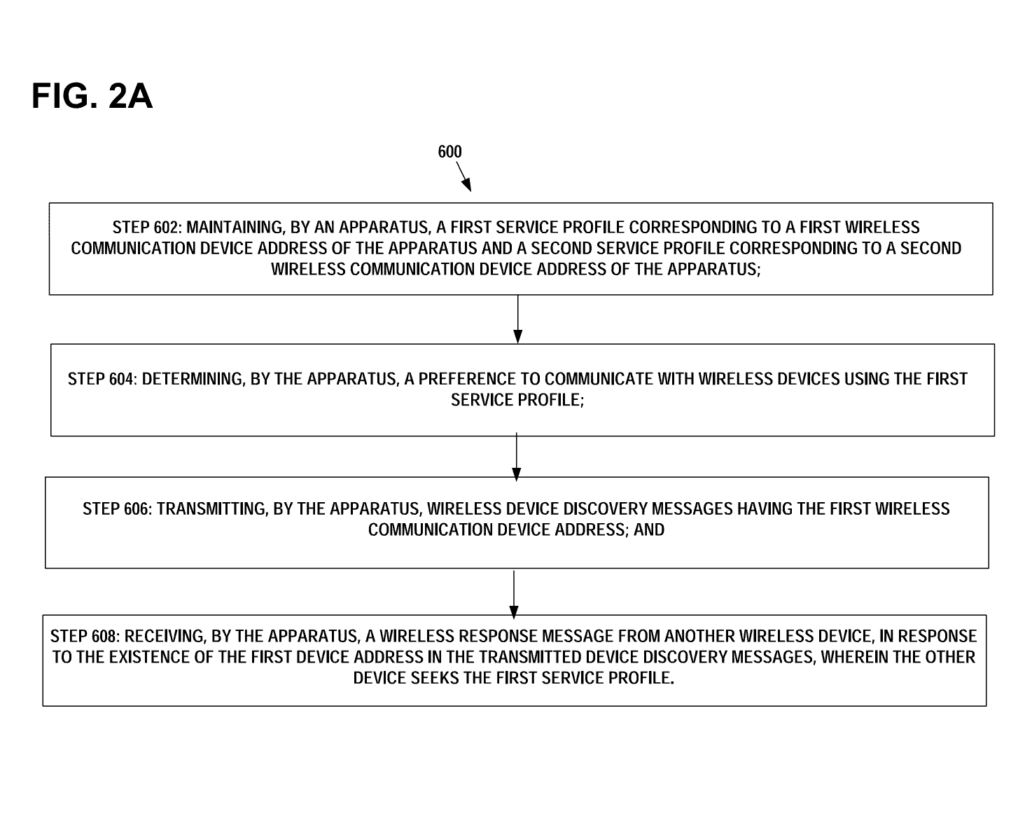

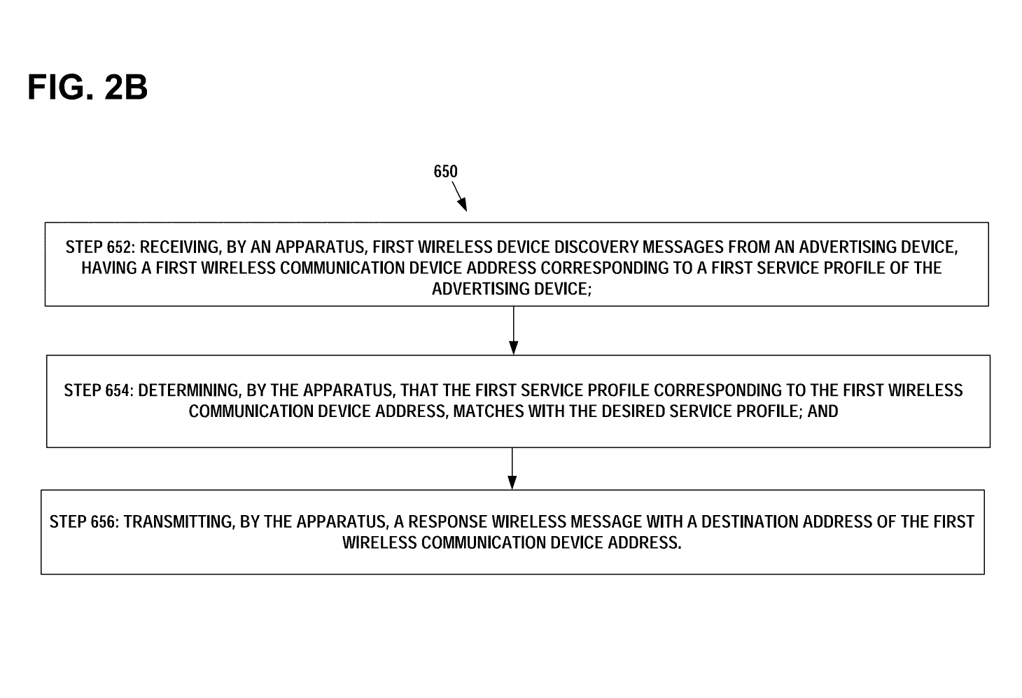

FIG. 2A is an illustration of an example flow diagram 600 of an example process in the mobile wireless device 100, in accordance with at least one embodiment of the present invention. The steps of the flow diagram represent computer code instructions stored in the RAM and/or ROM memory of the device 100, which when executed by the central processing units (CPU) 125, carry out the functions of the example embodiments of the invention. The steps may be carried out in another order than shown and individual steps may be combined or separated into component steps. The flow diagram has the following steps:

Step 602: maintaining, by an apparatus, a first service profile corresponding to a first wireless communication device address of the apparatus and a second service profile corresponding to a second wireless communication device address of the apparatus;

Step 604: determining, by the apparatus, a preference to communicate with wireless devices using the first service profile;

Step 606: transmitting, by the apparatus, wireless device discovery messages having the first wireless communication device address; and

Step 608: receiving, by the apparatus, a wireless response message from another wireless device, in response to the existence of the first device address in the transmitted device discovery messages, wherein the other device seeks the first service profile.

FIG. 2B is an illustration of an example flow diagram 650 of an example process in the device 102A, in accordance with at least one embodiment of the present invention. The steps of the flow diagram represent computer code instructions stored in the RAM and/or ROM memory of the device 102A, which when executed by the central processing units (CPU) 125, carry out the functions of the example embodiments of the invention. The steps may be carried out in another order than shown and individual steps may be combined or separated into component steps. The flow diagram has the following steps:

Step 652: receiving, by an apparatus, first wireless device discovery messages from an advertising device, having a first wireless communication device address corresponding to a first service profile of the advertising device;

Step 654: determining, by the apparatus, that the first service profile corresponding to the first wireless communication device address, matches with the desired service profile; and

Step 656: transmitting, by the apparatus, a response wireless message with a destination address of the first wireless communication device address.

FIG. 3 illustrates an example embodiment of the invention, wherein examples of removable storage media are shown, based on magnetic, electronic and/or optical technologies, such as magnetic disks, optical disks, semiconductor memory circuit devices, inbuilt internal flash/eeprom memory, and micro-SD memory cards (SD refers to the Secure Digital standard) for storing data and/or computer program code as an example computer program product, in accordance with at least one embodiment of the present invention.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific example embodiments have been disclosed, a person skilled in the art will understand that changes can be made to the specific example embodiments without departing from the spirit and scope of the invention.

1. A method, comprising:
maintaining, by an apparatus, a first service profile corresponding to a first wireless communication device address of the apparatus, which is at least one of a Public Bluetooth LE address or a first Bluetooth LE private address, and a second service profile corresponding to a second wireless communication device address of the apparatus, which is a second Bluetooth LE private address;
determining, by the apparatus, a preference for one of either the first service profile or the second service profile to be used to communicate with wireless devices;
transmitting, by the apparatus, wireless device discovery messages having the first wireless communication device address, if the first service profile is determined to be preferred; and
transmitting, by the apparatus, wireless device discovery messages having the second wireless communication device address, if the second service profile is determined to be preferred.

2. The method of claim 1, further comprising:
receiving, by the apparatus, a wireless response message from another wireless device, in response to the existence of the first device address in the transmitted device discovery messages, wherein the other device seeks the first service profile;
wherein the other device seeks the first service profile, but does not seek the second service profile.

3. The method of claim 2, wherein the other device and the apparatus have previously been connected so that the other device knows that by contacting the first wireless communication device address, the other device can reach the first service profile it seeks.

4. The method of claim 1, further comprising:
transmitting, by the apparatus, wireless device discovery messages having the second wireless communication device address; and
receiving, by the apparatus, a wireless response message from another wireless device, in response to the existence of the second device address in the transmitted device discovery messages, wherein the other device seeks the second service profile.

5. The method of claim 1, wherein the first wireless communication device address of the apparatus is one of a public device address of the apparatus or a random device address and the second wireless communication device address of the apparatus is one of a public device address of the apparatus or a random device address.

6. A method, comprising:
maintaining, by an apparatus, a first service profile and a second service profile;
receiving, by the apparatus, first wireless device discovery messages from an advertising device, having a first wireless communication device address of the advertising device, which is at least one of a Public Bluetooth LE address or a first Bluetooth LE private address, corresponding to the first service profile and second wireless device discovery messages from the advertising device, having a second wireless communication device address of the advertising device, which is a second Bluetooth LE private address, corresponding to the second service profile;
determining, by the apparatus, a preference for one of either the first service profile or the second service profile;
determining, by the apparatus, that the first service profile corresponding to the first wireless communication device address, matches with the preferred service profile, if the first service profile is determined to be preferred; and
transmitting, by the apparatus, a response wireless message with a destination address of the first wireless communication device address.

7. The method of claim 6, further comprising:
storing, by the apparatus, the first wireless communication device address in association with a representation of the first service profile.

8. The method of claim 6, further comprising:
wherein the wireless discovery messages transmitted by the wireless communication device include a unique identifier representing the first service profile.

9. An apparatus, comprising:
at least one processor;
at least one memory including computer program code;
the at least one memory and the computer program code configured to, with the at least one processor, cause the apparatus at least to:
maintain a first service profile corresponding to a first wireless communication device address of the apparatus, which is at least one of a Public Bluetooth LE address or a first Bluetooth LE private address, and a second service profile corresponding to a second wireless communication device address of the apparatus, which is a second Bluetooth LE private address;
determine a preference for one of either the first service profile or the second service profile to be used to communicate with wireless devices;
transmit wireless device discovery messages having the first wireless communication device address, if the first service profile is determined to be preferred; and
transmit wireless device discovery messages having the second wireless communication device address, if the second service profile is determined to be preferred.

10. The apparatus of claim 9, further comprising:
the at least one memory and the computer program code configured to, with the at least one processor, cause the apparatus at least to:
receive a wireless response message from another wireless device, in response to the existence of the first device address in the transmitted device discovery messages, wherein the other device seeks the first service profile;
wherein the other device seeks the first service profile, but does not seek the second service profile.

11. The apparatus of claim 10, wherein the other device and the apparatus have previously been connected so that the other device knows that by contacting the first wireless communication device address, the other device can reach the first service profile it seeks.

12. The apparatus of claim 9, further comprising:
transmit wireless device discovery messages having the second wireless communication device address; and
receive a wireless response message from another wireless device, in response to the existence of the second device address in the transmitted device discovery messages, wherein the other device seeks the second service profile.

13. The apparatus of claim 9, wherein the first wireless communication device address of the apparatus is one of a public device address of the apparatus or a random device address and the second wireless communication device address of the apparatus is one of a public device address of the apparatus or a random device address.

14. An apparatus, comprising:
at least one processor;
at least one memory including computer program code;
the at least one memory and the computer program code configured to, with the at least one processor, cause the apparatus at least to:
maintain a first service profile and a second service profile;
receive first wireless device discovery messages from an advertising device, having a first wireless communication device address of the advertising device, which is at least one of a Public Bluetooth LE address or a first Bluetooth LE private address, corresponding to the first service profile and second wireless device discovery messages from the advertising device, having a second wireless communication device address of the advertising device, which is a second Bluetooth LE private address, corresponding to the second service profile;
determine a preference for one of either the first service profile or the second service profile;
determine that the first service profile corresponding to the first wireless communication device address, matches with the preferred service profile, if the first service profile is determined to be preferred; and
transmit a response wireless message with a destination address of the first wireless communication device address.

15. The apparatus of claim 14, further comprising:
store the first wireless communication device address in association with a representation of the first service profile.

16. The apparatus of claim 14, further comprising:
wherein the wireless discovery messages transmitted by the wireless communication device include a unique identifier representing the first service profile.

17. The apparatus of claim 14, wherein the first service profile is Internet Protocol Support Profile (IPSP).

18. A computer program product comprising computer executable program code recorded on a computer readable, non-transitory storage medium, the computer executable program code comprising:
code for maintaining, by an apparatus, a first service profile corresponding to a first wireless communication device address of the apparatus, which is at least one of a Public Bluetooth LE address or a first Bluetooth LE private address, and a second service profile corresponding to a second wireless communication device address of the apparatus, which is a second Bluetooth LE private address;
code for determining, by the apparatus, a preference for one of either the first service profile or the second service profile to be used to communicate with wireless devices;
code for transmitting, by the apparatus, wireless device discovery messages having the first wireless communication device address, if the first service profile is determined to be preferred; and
code for transmitting, by the apparatus, wireless device discovery messages having the second wireless communication device address, if the second service profile is determined to be preferred.

19. The computer program product of claim 18, further comprising:
code for transmitting, by the apparatus, wireless device discovery messages having the second wireless communication device address; and
code for receiving, by the apparatus, a wireless response message from another wireless device, in response to the existence of the second device address in the transmitted device discovery messages, wherein the other device seeks the second service profile.

20. A computer program product comprising computer executable program code recorded on a computer readable, non-transitory storage medium, the computer executable program code comprising:
code for maintaining, by an apparatus, a first service profile and a second service profile;
code for receiving, by the apparatus, first wireless device discovery messages from an advertising device, having a first wireless communication device address of the advertising device, which is at least one of a Public Bluetooth LE address or a first Bluetooth LE private address, corresponding to the first service profile and second wireless device discovery messages from the advertising device, having a second wireless communication device address of the advertising device, which is a second Bluetooth LE private address, corresponding to the second service profile;
code for determining, by the apparatus, a preference for one of either the first service profile or the second service profile;
code for determining, by the apparatus, that the first service profile corresponding to the first wireless communication device address, matches with the preferred service profile, if the first service profile is determined to be preferred; and
code for transmitting, by the apparatus, a response wireless message with a destination address of the first wireless communication device address.

21. The computer program product of claim 20, further comprising:
code for storing, by the apparatus, the first wireless communication device address in association with a representation of the first service profile.
